(19) United States
(12) Patent Application Publication
(10) Pub. No.: US 2026/0280376 A1
(43) Pub. Date: Sep. 17, 2026

(54) Slot Closure Device for an Electrical Machine, Method for Closing a Slot of an Electrical Machine, Electrical Machine, and Motor Vehicle

(71) Applicant: Bayerische Motoren Werke Aktiengesellschaft, Muenchen (DE)

(72) Inventor: Martin STREBL, Muenchen (DE)

(21) Appl. No.: 19/479,906

(22) PCT Filed: Apr. 23, 2024
(86) PCT No.: PCT/EP2024/060986

§ 371 Date: Oct. 29, 2025

(30) Foreign Application Priority Data
May 30, 2023 (DE) 10 2023 114 057.4

(51) Int. Cl. H02K 3/487; H02K 15/13

(52) U.S. Cl. CPC H02K 3/487; H02K 15/13

(57) ABSTRACT

A slot closure device for an electrical machine includes wing parts connected to one another and spaced from one another at a straight slit of a slot closure body. The slit includes a first bracing bar seat arranged on the slit base and a smaller, second bracing bar seat, and a straight bracing bar. By moving the bracing bar from one of the bracing bar seats to the other, it is possible to adjust the slot closure device between a mounting position, in which the wing parts are relaxed due to the bracing bar sitting in the first bracing bar seat with a form fit, and a bracing position, in which the wing parts are braced laterally apart from one another by the bracing bar sitting in the second bracing bar seat with a form fit.

### BACKGROUND AND SUMMARY

The present invention relates to a slot closure device for closing a slot that is formed by two teeth of a rotor or stator of an electrical machine, said teeth being adjacent in the circumferential direction. The invention also relates to a method for closing such a slot. The invention also includes an electrical machine, the rotor and/or stator of which has the slot closure device, and a motor vehicle that is equipped with such an electrical machine.

Electrical machines have a stationary stator and a rotor. In externally excited electrical machines, the rotor bears rotor poles, which are each wound with wire. This results in a slot or a radially outwardly open pole gap between two rotor poles that are adjacent in the circumferential direction of the rotor. There is a need to close this slot or pole gap, since, during production of the electrical machine, pole gaps are filled with a casting compound in order to secure the wire windings. The casting compound should be prevented from escaping from the pole gaps. For this purpose, so-called sliding covers are known from the prior art, which are inserted into a corresponding sliding cover seat in the axial direction of the rotor or stator of the electrical machine. Such sliding covers are known, for example, from DE 10 2021 122 001 A1 or DE 10 2017 002 420 A1 . A problem of the insertion of the conventional sliding cover is that a chip is removed from the sliding cover by the metal laminated rotor or stator core when the sliding cover is inserted. If the chip remains undiscovered, it can cause damage during operation of the electrical machine, for instance if the chip is sucked in by a coolant or lubricant pump of the electrical machine. Therefore, considerable effort must currently still be made in the production of an electrical machine firstly to avoid chip removal from the sliding cover and secondly to inspect the electrical machine to establish whether an undesirable chip has nevertheless been removed from the sliding cover.

An object of the present invention is to simplify the production of an electrical machine.

This object is achieved by the subjects of the present disclosure. Further possible embodiments of the invention are also disclosed in the description and the figures. Features, advantages and possible embodiments presented in the description for one of the subjects disclosed herein are to be regarded as applying across categories and embodiments at least analogously as features, advantages and possible embodiments of the respective other subjects disclosed herein and of any possible combination of the subjects disclosed herein.

According to the invention, a slot closure device for an electrical machine is proposed. The slot closure device is used during production of the electrical machine instead of a conventional sliding cover to close a slot formed or delimited by two teeth of a rotor or stator of the electrical machine, said teeth being adjacent in the circumferential direction. In addition, the invention proposes a method for closing such a slot, said method being carried out in particular during production of the electrical machine. The invention also includes an electrical machine, the rotor and/or stator of which have/has the slot closure device, and a motor vehicle that has the electrical machine. The electrical machine is in particular an electrical traction machine or prime mover, which means that the motor vehicle is in particular a solely electrically or hybrid-electrically driven motor vehicle.

The slot closure device has a slot closure body with two lateral wing parts. The slot closure body is an elongate, straight component and is at least roughly T-shaped when viewed in cross section. The slot closure device also has a slit, in particular a straight slit, which follows the slot closure body along its longitudinal direction. The wing parts are spaced from one another via the slit or via an opening width of the slit (as viewed in cross section). The wing parts are however connected to one another in the region of a slit bottom or slit base of the slit. The slit has two bracing bar seats, specifically a first bracing bar seat, which is arranged on the slit bottom, and a second bracing bar seat, which is arranged over the first bracing bar seat transversely to the longitudinal direction. The second bracing bar seat is smaller than the first bracing bar seat. Each bracing bar seat manifests as a widening of the slit when the slot closure device or the slot closure body is viewed in cross section. The slot closure device also includes a bracing bar, in particular a straight bracing bar, which is arranged in the slit, i.e., form-fittingly in the first bracing bar seat or form-fittingly in the second bracing bar seat. The slot closure device is put into a mounting position or into a bracing position depending on the bracing bar seat in which the bracing bar is arranged. In other words, the slot closure device can be moved between the mounting position and the bracing position by moving the bracing bar within the slit out of one of the bracing bar seats into the other bracing bar seat. In the mounting position, i.e., when the bracing bar is in the first, larger bracing bar seat, the wing parts are relaxed, and the slit is correspondingly narrow, resulting in a small bracing width of the wing parts. In contrast, when the bracing bar is in the second, smaller bracing bar seat, i.e., in the bracing position of the slot closure device, the wing parts are laterally braced apart by a width of the bracing bar, and the slit is correspondingly wide; the bracing width of the wing parts is correspondingly large.

During production of the electrical machine, the slot closure device is moved into the mounting position and then inserted into the slot of the rotor or stator, if this has not yet happened. The slot closure device is then moved out of the mounting position into the bracing position by moving the bracing bar within the slit radially outward out of the first bracing bar seat into the second bracing bar seat. Since the bracing width of the wing parts of the slot closure device is particularly small in the mounting position, it is not necessary for the slot closure body to slide directly on the laminated core of the rotor/stator, and therefore the removal of a material chip from the slot closure body can be prevented in a simple manner. The slot closure device is moved into its bracing position only when the slot closure body is at least roughly positioned in the corresponding slot as intended. In the process, laterally outer wing tips of the wing parts engage in a corresponding form fit element of the rotor/stator so that a form fit is formed between the rotor/stator and the slot closure device. As a result, an advantageously particularly reliable sealing effect is achieved, and the slot closure body is secured particularly securely in its intended installation position.

The production of the electrical machine is simplified further when, as provided by a possible development of the method, the slot closure device in the mounting position is inserted into the slot in a radial direction of the electrical machine. This means that in this case an insertion of the slot closure body in the axial direction of the electrical machine (parallel to a rotor shaft longitudinal central axis) is omitted. As a result, the likelihood that a chip is undesirably removed from the slot closure body is almost completely eliminated. The solely radial insertion of the slot closure body is made possible by the bracing width of the wing elements in the mounting position, which is smaller than the bracing width of the wing elements in the bracing position.

According to a possible embodiment of the slot closure device, the bracing bar is designed as a straight oval cylinder, in particular in a straight circular cylindrical manner. The bracing bar can thus be displaced particularly easily out of the first bracing bar seat into the second bracing bar seat. Thanks to the absence of longitudinal edges of the bracing bar on the outer circumferential side, the bracing bar slides particularly easily on the material of the slot closure body on the inside in the slit. Therefore, the movement of the slot closure device into the bracing position is particularly simple. The movement of the slot closure device out of its bracing position into the mounting position is also simplified owing to the oval cylindrical, in particular straight circular cylindrical, shape of the bracing bar. In a possible alternative, the bracing bar has a straight prismatic design. In this case, a particularly reliable fit of the bracing bar in the corresponding bracing bar seat is ensured. The slot closure device can thereby be handled more easily without the bracing bar being pulled out of the corresponding bracing bar seat in an undesirable manner. In addition, the reliable fit of the bracing bar in the second bracing bar seat helps to ensure an advantageously particularly high level of operating safety of the electrical machine.

In a further possible embodiment, it is provided for the bracing bar to be designed as a hollow bar. As a result, the bracing bar is particularly lightweight, and, in combination with the slit, the slot closure device is more lightweight, in particular in comparison with conventional sliding covers. This results in a particularly lightweight rotor/stator and consequently in a particularly lightweight electrical machine. Furthermore, during operation of the electrical machine, particularly low forces act on the bracing bar when the bracing bar is inserted in/on the rotor of the electrical machine owing to the particularly low mass of the bracing bar.

According to a further possible embodiment, the bracing bar is formed from a metallic material, in particular from a light metal such as magnesium, aluminum, titanium, etc. Of course, light metal alloys are likewise suitable. In addition, at least one alternative embodiment of the bracing bar is conceivable in which it is produced from a plastic, in particular from a fiber-reinforced plastic. In this way, the bracing bar is both particularly lightweight and particularly stable.

In a possible development of the slot closure device, the wing parts of the slot closure body are connected to one another in a reversible, elastic manner, i.e., the wing parts can yield relative to one another. For example, the wing parts are integrally joined to one another, in particular designed as a single piece with one another. It is generally the case for the slot closure device, i.e., regardless of the embodiment, that the slot closure body can be designed, for example, as a plastic part that is produced by injection molding. It is also conceivable for the slot closure body to be produced by extrusion. Because the wing parts are fastened integrally to one another, a further simplification of the production of the electrical machine results, since particularly few individual parts have to be handled in order to assemble the electrical machine.

In a further possible embodiment, a viscoelastic material body is arranged on a slot engagement side of the slot closure body. In the intended installation position of the slot closure device, the viscoelastic material body bears particularly closely against outer wire windings of wire windings with which the corresponding rotor or stator tooth is wound. For example, a material of the viscoelastic material body is a viscoelastic polyurethane. In this way, the wire windings are positionally secured by the viscoelastic material body. This is a particular advantage of the slot closure device, since filling the slots with a conventional casting compound for positional securing of the wire windings can be omitted thanks to the viscoelastic material body. As a result, the effort to be made to produce the electrical machine is significantly reduced. It is not only the case that the component of casting compound per se can be omitted, but also an amount of energy that had to be used to melt and/or cure the casting compound is omitted. Furthermore, the electrical machine without casting compound is particularly lightweight, which leads to a particularly lightweight motor vehicle. As a result, concerns for particularly environmentally friendly production of the electrical machine and for a motor vehicle that can be operated in a particularly energy-efficient manner with low emissions can in particular be taken into account.

Further features of the invention can be found in the figures and the description of the figures. The features and combinations of features mentioned in the description above and the features and combinations of features mentioned in the description of the figures below and/or shown solely in the figures can be used not only in the combination given in each case but also in other combinations or alone without departing from the scope of the invention.

### BRIEF DESCRIPTION OF THE DRAWINGS

FIG. 1 shows a cross-sectional figure of a slot closure device that is arranged in a mounting position,

FIG. 2 shows a cross-sectional figure of a slot closure device that is arranged in a bracing position, and

FIGS. 3a, 3b, and 3c show the following to illustrate a method for closing a slot by the slot closure device, in each case schematically: where FIG. 3a shows the insertion of the slot closure device into the slot, FIG. 3b shows the slot closure device positioned roughly in the slot in the mounting position, and FIG. 3c shows the slot closure device closing the slot in the bracing position of the slot closure device.

### DETAILED DESCRIPTION OF THE DRAWINGS

In the figures, identical and functionally identical elements are provided with the same reference sign.

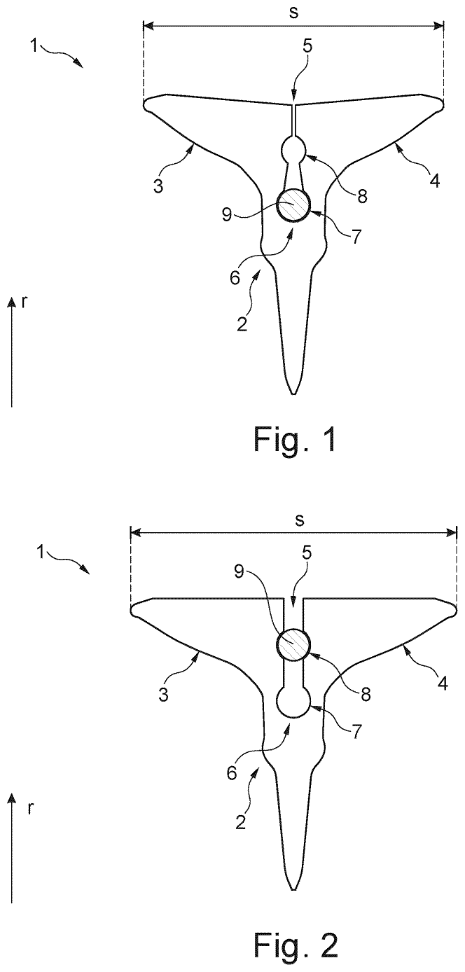

FIGS. 1 and 2 each show a cross-sectional figure of a slot closure device 1 by which a component of an electrical machine 10 is formed. In the present example, the electrical machine 10 is an electrical traction machine for a solely electrically or hybrid-electrically driven motor vehicle (not shown). As can be seen in FIG. 1, the elongate slot closure device 1 has a substantially T-shaped slot closure body 2, which has two lateral wing parts 3, 4. Furthermore, the slot closure device 1 has a slit 5, at the slit bottom 6 of which the wing parts 3, 4 are integrally joined to one another. The slit 5 has two bracing bar seats 7, 8, of which a first bracing bar seat 7 forms a part of the slit 5 in the region of the slit bottom 6. The second bracing bar seat 8 is arranged above the first bracing bar seat 7, i.e., radially further outward than the first bracing bar seat 7 in relation to a radial direction r of the slot closure device 1 or of the electrical machine 10. A part of the slit 5 is likewise formed by the second bracing bar slit 8. The first bracing bar seat 7 arranged on the slit bottom 6 is larger than the second bracing bar seat 8 arranged above. The slot closure device 1 is movable between a mounting position and a bracing position, for which purpose it comprises a bracing bar 9, which is arranged in the slit 5. The bracing bar 9 can be designed as a straight prism or, as shown in the present case, as a straight circular cylinder. Although not shown in the figures, the bracing bar 9 can be designed as a hollow bar. In the present case, the bracing bar 9 is made of aluminum. However, other materials are just as conceivable, for example another metal, in particular light metal, a plastic, etc.

The slot closure device 1 is put into the mounting position (see FIG. 1) or into the bracing position (see FIG. 2) depending on the bracing bar seat 7, 8 in which the bracing bar 9 is arranged. In the mounting position, i.e., when the bracing bar 9 is in the first, larger bracing bar seat 7, the wing parts 3, 4 are relaxed, and the slit 5 is correspondingly narrow, resulting in a small bracing width s of the wing parts 3, 4. In contrast, when the bracing bar 9 is in the second, smaller bracing bar seat 8, i.e., in the bracing position of the slot closure device 1, the wing parts 3, 4 are laterally braced apart by a width of the bracing bar 9, and the slit 5 is correspondingly wide; the bracing width s of the wing parts 3, 4 is then correspondingly large, i.e., larger than in the mounting position of the slot closure device 1. Accordingly, the slot closure device 1 is movable from its mounting position (FIG. 1) into the bracing position (FIG. 2) by moving the bracing bar 9 within the slit 5 out of the first bracing bar seat 7 into the second bracing bar seat 8. Conversely, the slot closure device 1 is movable from its bracing position (FIG. 2) into the mounting position (FIG. 1) by moving the bracing bar 9 within the slit 5 out of the second bracing bar seat 8 into the first bracing bar seat 7.

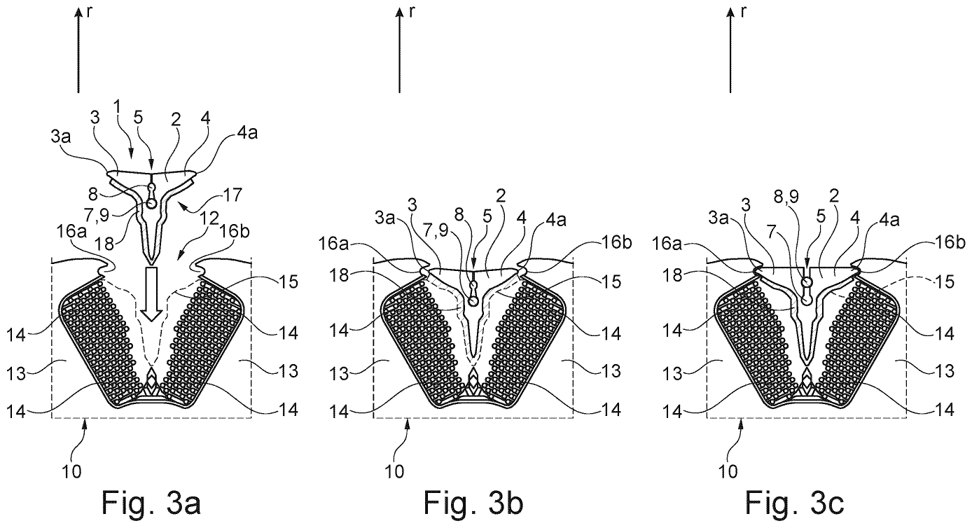

A method for closing a slot 12 of the electrical machine 10 is illustrated using the example of a rotor 11 of the electrical machine 10 in FIGS. 3a, 3b and 3c. Such a slot 12 is formed or delimited by two rotor teeth 13 or rotor poles of the rotor 11 of the electrical machine 10, said rotor teeth being adjacent in the circumferential direction. Each rotor tooth is wound with a plurality of wire windings 14, not all of which are shown, and only a few of which are provided with the corresponding reference sign, for reasons of clarity. In FIGS. 3a and 3b, a dashed line can be seen in this connection, said line characterizing an arrangement of outer-lying wire windings 14.

In the method, the slot closure device 1 is moved into the mounting position, if this has not yet happened. The slot closure device 1 is then inserted into the slot 12 of the rotor 11. In the present example, the slot closure body 2 is not pushed axially into/onto the rotor 11 at all. Instead, the slot closure body 2 is inserted into the slot 12 in an exclusively radial direction or exclusively in radial direction r. This is shown in FIG. 3a. FIG. 3b shows how the slot closure device 1 is inserted into the slot 12, wherein wing tips 3a, 4a of the wing parts 3, 4 and corresponding form fit elements 16a, 16b of the rotor 11 are roughly aligned with one another. The slot closure device 1 is then moved out of the mounting position into the bracing position by moving the bracing bar 9 within the slit 5 radially outward out of the first bracing bar seat 7 into the second bracing bar seat 8. The wing parts 3, 4 (which can also be referred to as flanks) are thereby pushed outward and form a form fit and force fit with the laminated core of the rotor 11. It can be seen in FIG. 3c how the laterally outer wing tips 3a, 4a of the wing parts 3, 4 engage in the corresponding form fit element 16a or 16b of the rotor 11 so that a form fit is formed between the rotor 11 and the slot closure device 1.

According to the present example, an optional viscoelastic material body 18 is arranged on a slot engagement side 17 of the slot closure body 2. This is shown in FIGS. 3a, 3b and 3c and bears particularly closely against the winding contour 15, i.e., against the outer wire windings of the wire windings 14; see FIG. 3c. For example, viscoelastic polyurethane is provided for a material of the viscoelastic material body 18. The wire windings 14 are positionally secured against undesirable slipping by the material body 18. Thanks to the viscoelastic material body 18, the filling of the slots 12 of the electrical machine 10 with a conventional casting compound can be omitted.

The slot closure device 1 and the method for closing the slot 12 by the slot closure device 1 each represent a way of simplifying production of an electrical machine. The resulting advantages lead to the particularly advantageously designed electrical machine 10 and to the particularly advantageous motor vehicle.

### List of Reference Signs

1 Slot closure device
2 Slot closure body
3 Wing part
3a Wing tip
4 Wing part
4a Wing tip
5 Slit
6 Slit bottom
7 First bracing bar seat
8 Second bracing bar seat
9 Bracing bar
10 Electrical machine
11 Rotor
12 Slot
13 Rotor tooth (rotor pole)
14 Wire winding
15 Winding contour
16a Form fit element
16b Form fit element
17 Slot engagement side
18 Viscoelastic material body
r Radial direction
s Bracing width

1-10. (canceled)

11. A slot closure device for an electrical machine, the slot closure device comprising:
a slot closure body comprising two lateral wing parts;
a straight slit that extends in a longitudinal direction of the slot closure body, wherein, at a slit bottom of the slit, the wing parts are connected to one another,
wherein the slit comprises:
a first bracing bar seat that is arranged on the slit bottom; and
a second bracing bar seat that is smaller than the first bracing bar seat and is arranged over the first bracing bar seat perpendicularly to the longitudinal direction; and
a bracing bar that is arranged in the slit along the longitudinal direction,
wherein the slot closure device is movable by moving the bracing bar within the slit out of one of the bracing bar seats into the other bracing bar seat, between:
a mounting position in which the wing parts are relaxed owing to the bracing bar sitting form-fittingly in the first bracing bar seat,
and a bracing position in which the wing parts are laterally braced apart by the bracing bar sitting form-fittingly in the second bracing bar seat,
wherein a bracing width of the wing parts is smaller in the mounting position than in the bracing position.

12. The slot closure device according to claim 11,
wherein the bracing bar is configured as a straight circular cylinder or a straight prism.

13. The slot closure device according to claim 11,
wherein the bracing bar comprises a hollow bar.

14. The slot closure device according to claim 11,
wherein the bracing bar is formed from a metallic material.

15. The slot closure device according to claim 11,
wherein the wing parts are integrally joined to one another at the slit bottom.

16. The slot closure device according to claim 11, comprising:
a viscoelastic material body arranged on a slot engagement side of the slot closure body.

17. An electrical machine comprising:
a rotor and/or a stator further comprising the slot closure device according to claim 11.

18. A motor vehicle comprising:
the electrical machine according to claim 17.

19. A method comprising:
closing, by a slot closure device, a slot that is formed by two teeth of a rotor or stator of an electrical machine, said teeth being adjacent in a circumferential direction,
wherein the slot closure device comprises:
a slot closure body comprising two lateral wing parts;
a straight slit that extends in a longitudinal direction of the slot closure body,
wherein, at a slit bottom of the slit, the wing parts are connected to one another,
wherein the slit comprises:
a first bracing bar seat that is arranged on the slit bottom; and
a second bracing bar seat that is smaller than the first bracing bar seat and is arranged over the first bracing bar seat perpendicularly to the longitudinal direction; and
a bracing bar that is arranged in the slit along the longitudinal direction,
wherein the slot closure device is movable by moving the bracing bar within the slit out of one of the bracing bar seats into the other bracing bar seat, between:
a mounting position in which the wing parts are relaxed owing to the bracing bar sitting form-fittingly in the first bracing bar seat,
and a bracing position in which the wing parts are laterally braced apart by the bracing bar sitting form-fittingly in the second bracing bar seat,
wherein a bracing width of the wing parts is smaller in the mounting position than in the bracing position;
wherein the method comprises:
inserting the slot closure device into the slot in the mounting position; and
moving the slot closure device out of the mounting position into the bracing position by moving the bracing bar within the slit radially outward in a radial direction out of the first bracing bar seat into the second bracing bar seat.

20. The method according to claim 19, comprising:
inserting the slot closure device in the mounting position into the slot in the radial direction of the electrical machine.
